(19) United States
(12) Patent Application Publication
(10) Pub. No.: US 2022/0245771 A1
(43) Pub. Date: Aug. 4, 2022

(54) ELECTRONIC DEVICE CAPABLE OF CORRECTING DEPTH INFORMATION AND PERFORMING BOKEH PROCESSING ON IMAGE AND METHOD OF CONTROLLING ELECTRONIC DEVICE

(71) Applicant: GUANGDONG OPPO MOBILE TELECOMMUNICATIONS CORP., LTD., Dongguan (CN)

(72) Inventor: Hirotake CHO, Yokohama-shi (JP)

(21) Appl. No.: 17/725,136

(22) Filed: Apr. 20, 2022

Related U.S. Application Data
(63) Continuation of application No. PCT/CN2019/124146, filed on Dec. 9, 2019.

(51) Int. Cl. G06T 5/00; G06T 5/50; G06T 7/593

(52) U.S. Cl. CPC G06T 5/002; G06T 5/50; G06T 2207/10028; G06T 2207/10012; G06T 7/593

(57) ABSTRACT

An electronic device and a method for controlling an electronic device are provided, the electronic device includes a first camera used to acquire a first image, a second camera used to acquire a second image, a range sensor used to acquire ToF depth information, and an image signal processor used to acquire an image with bokeh based on the first image, the second image, and the ToF depth information. The image with bokeh is the first image with one or more bokeh portions. The image signal processor is used to acquire a depth information of a stereo image by matching the first image and the second image, correct the depth information of the stereo image based on the first image and the ToF depth information; and acquire the corrected depth information.

### CROSS-REFERENCE TO RELATED APPLICATION

This application is a continuation of International Application No. PCT/CN2019/124146, filed Dec. 9, 2019, the entire disclosure of which is incorporated herein by reference in its entirety.

### TECHNICAL FIELD

The present disclosure relates to an electronic device and a method of controlling an electronic device.

### BACKGROUND

A digital single lens reflex (DSLR) camera etc., has been used for generating an image with bokeh. In the image with bokeh, a portion that requires attention is made clearer and a foreground and a background of the portion is blurred. Namely, a portion that needs to get attention is made clearer and a foreground and a background of the portion is blurred.

In recent years, a technique of image processing in which an image with bokeh is generated artificially from an image taken with a camera having a deep depth of field, is widely spread. The camera having a deep depth of field is installed in an electronic device such as a smartphone and captures an image that is in focus from a short-distance portion to a long-distance portion.

A method of using depth information which is included in a stereo image taken through binocular stereo viewing is a technique employed to artificially produce an image with bokeh. By using the technique, an electronic device such as a smartphone can generate an image with bokeh.

However, the depth information may be false in some types of a surface of an object in a subject. For example, if a binocular stereo image has a low texture pattern that does not have a clear change along an epipolar line, or a repeated pattern such as checkered pattern, depth information cannot be accurately calculated. As a result, an image with inappropriate bokeh is generated. FIG. 21 shows an example of an image with bokeh in the prior art. Although a region B is actually an in-focus region, incorrect image processing is performed on the region B since depth information in the region B is false due to its repeated pattern.

Algorithms used in an image processing system available for electronic devices such as smartphones cannot be directly improved because the system is usually a black box for manufacturers of the electronic devices. Therefore, it is difficult to correct the depth information based on a stereo image.

### SUMMARY

In accordance with the present disclosure, an electronic device may include:

a first camera configured to acquire a first image of a subject;

a second camera configured to acquire a second image of the subject;

a range sensor configured to emit a pulsed light toward the subject and detect a reflected light of the pulsed light reflected from the subject, and acquire time of flight (ToF) depth information; and

an image signal processor configured to acquire an image with bokeh, based on the first image, the second image, and the ToF depth information, the image with bokeh being the first image with one or more bokeh portions,

the image signal processor is configured to acquire a depth information of a stereo image by matching the first image and the second image; correct the depth information of the stereo image based on the first image and the ToF depth information, and acquire the corrected depth information.

In accordance with the present disclosure, a method of controlling an electronic device, the electronic device including a first camera, a second camera, a range sensor, and an image signal processor, and the method including: acquiring, by the first camera, a first image of a subject; acquiring, by the second camera, a second image of the subject; acquiring, by the range sensor, ToF depth information of the subject; acquiring, by the image signal processor, a depth information of a stereo image by matching the first image and the second image; correcting, based on the first image and the ToF depth information, the depth information of the stereo image, and acquiring the corrected depth information; and acquiring, by the image signal processor, based on the corrected depth information, an image with bokeh; the image with bokeh being the first image with one or more bokeh portions.

### BRIEF DESCRIPTION OF THE DRAWINGS

These and/or other aspects and advantages of embodiments of the present disclosure will become apparent and more readily appreciated from the following descriptions made with reference to the drawings, in which:

FIG. 1 is a circuit diagram illustrating an example of a configuration of an electronic device according to an embodiment of the present disclosure.

FIG. 2 is a diagram illustrating an example of a flow of data for generating a camera image with bokeh by the electronic device shown in FIG. 1.

FIG. 3 is a diagram illustrating an example of a flow for generating a camera image with bokeh.

FIG. 4A is a diagram illustrating an example of the master camera image taken by the electronic device shown in FIG. 1.

FIG. 4B is a diagram illustrating an example of the ToF depth information corresponding to the master camera image shown in FIG. 4A.

FIG. 5A is a diagram illustrating an example of the depth information corresponding to the master camera image shown in FIG. 4A.

FIG. 5B is a diagram illustrating an example of a camera image with bokeh acquired by performing bokeh processing on the master camera image based on non-corrected depth information.

FIG. 6 is a diagram illustrating an example of a flow of correct region acquisition processing performed in the electronic device shown in FIG. 1.

FIG. 7 is a diagram illustrating an example of a main camera image in which a correct region is specified on the display module.

FIG. 8 is a diagram illustrating an example of a flow of the uncertain region detection processing performed in the electronic device shown in FIG. 1.

FIG. 9 is a diagram illustrating an autocorrelation calculation model in the flow of the uncertain region detection processing shown in FIG. 8.

FIG. 10A is a diagram illustrating an example of a relationship between the movement of a reference region relative to a region of interest in an uncertain region that is labeled as a low texture region and the similarity obtained by means of the autocorrelation.

FIG. 10B is a diagram illustrating an example of a relationship between the movement of a reference region relative to a region of interest in an uncertain region that is labeled as a repeated pattern region and the similarity obtained by means of the autocorrelation calculation.

FIG. 11 is a diagram illustrating an example of an uncertain region labeled as a low texture region and an example of an uncertain region labeled as a repeated pattern region.

FIG. 12 is a diagram illustrating an example of a flow of combining operations in the uncertain region detection processing shown in FIG. 8.

FIG. 13A is a diagram illustrating an example of a relationship between frequency (characteristic value) and texture labeling.

FIG. 13B is a diagram illustrating an example of a relationship between differences in similarity.

FIG. 14 is a diagram illustrating an example of a flow of the depth information correction processing shown in FIG. 3.

FIG. 15 is a diagram illustrating an example of criteria for excluding an incorrect set of the depth information and the ToF depth information.

FIG. 16A is a diagram illustrating an example in which peripheral regions are added to FIG. 5A.

FIG. 16B is a diagram in which peripheral regions are added to FIG. 4B.

FIG. 17 is a diagram illustrating an example of the depth information after replacement processing.

FIG. 18A is a diagram in which peripheral regions are added to FIG. 5A.

FIG. 18B is a diagram illustrating another example in which peripheral regions are added to FIG. 4B.

FIG. 19 is a diagram illustrating another example of the depth information after replacement processing.

FIG. 20 is a diagram illustrating an example of a camera image after the depth information correction processing according to the present disclosure.

FIG. 21 is a diagram illustrating an example of a camera image with inadequate bokeh.

### DETAILED DESCRIPTION OF EMBODIMENTS

Embodiments of the present disclosure will be described in detail and examples of the embodiments will be illustrated in the accompanying drawings. The same or similar elements and the elements having same or similar functions are denoted by like reference numerals throughout the descriptions. The embodiments described herein with reference to the drawings are explanatory, which aim to illustrate the present disclosure, but shall not be construed to limit the present disclosure.

<Electronic device 100>

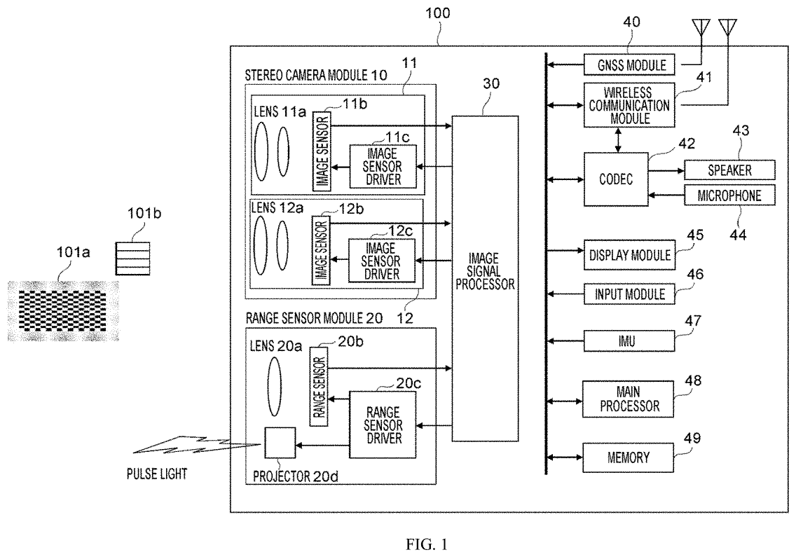

FIG. 1 is a circuit diagram illustrating an example of a configuration of an electronic device 100 according to an embodiment of the present disclosure. Reference numerals 101a and 101b depict subjects (target objects). The subject 101a is relatively close and the subject 101b is relatively far away.

As shown in FIG. 1, the electronic device 100 includes a stereo camera module 10, a range sensor module (also referred to as range senor) 20, and an image signal processor 30 that controls the stereo camera module 10 and the range sensor module 20. The image signal processor 30 processes camera image data acquired from the stereo camera module 10.

The stereo camera module 10 includes a master camera module (also referred to as first camera) 11 and a slave camera module (also referred to as second camera) 12 for the use for binocular stereo viewing as shown in FIG. 1.

The master camera module 11 includes a first lens 11a that is capable of focusing on a subject, a first image sensor 11b that detects an image inputted via the first lens 11a, and a first image sensor driver 11c that drives the first image sensor 11b, as shown in FIG. 1.

The slave camera module 12 includes a second lens 12a that is capable of focusing on a subject, a second image sensor 12b that detects an image inputted via the second lens 12a, and a second image sensor driver 12c that drives the second image sensor 12b, as shown in FIG. 1.

The master camera module 11 acquires a master camera image (also referred to as first image) of the subjects 101a and 101b. Similarly, the slave camera module 12 acquires a slave camera image (also referred to as second image) of the subjects 101a and 101b.

The range sensor module 20 acquires time of flight (ToF) depth information (ToF depth value) by emitting pulsed light toward the subjects 101a and 101b, and detecting reflection light from the subjects 101a and 101b. The ToF depth information indicates an actual distance between the electronic device 100 and a subject.

The resolution of the ToF depth information detected by the range sensor module 20 is lower than the resolution of stereo depth information of a stereo image that is acquired based on the master camera image and the slave camera image. A warp processing (ToF depth expansion processing) Y2 is performed to expand the ToF information to a field of view (FOV) of the master camera image.

The image signal processor 30 controls the master camera module 11, the slave camera module 12, and the range sensor module 20 to acquire a camera image. The camera image is the master camera image with bokeh. The camera image is acquired based on the master camera image obtained by means of the master camera module 11, the slave camera image obtained by means of the slave camera module 12, and the ToF depth information obtained by means of the range sensor module 20.

Furthermore, as shown in FIG. 1, the electronic device 100 includes a global navigation satellite system (GNSS) module 40, a wireless communication module 41, a CODEC 42, a speaker 43, a microphone 44, a display module (also referred to as display, e.g., display screen) 45, an input module (also referred to as input apparatus, e.g., touch screen) 46, an inertial measurement unit (IMU) 47, a main processor 48, and a memory 49.

The GNSS module 40 measures the current position of the electronic device 100. The wireless communication module 41 performs wireless communications with the Internet. The CODEC 42 bi-directionally performs encoding and decoding, using a predetermined encoding/decoding method, as shown in FIG. 1. The speaker 43 outputs a sound in accordance with sound data decoded by the CODEC 42. The microphone 44 outputs sound data to the CODEC 42 based on inputted sound.

The display module 45 displays predefined information. For example, the display module 45 displays a master camera image so that a user can check it.

The input module 46 inputs information via a user's operation. For example, the input module 46 inputs a position information which indicates a portion of the master camera image displayed on the display module 45. The position information is an in-focus position 210 shown in FIG. 7. The in-focus position 210 defines a correct region Rc described later. Please note that the image signal processor 30 or the main processor 48 may specify the in-focus position 210.

An IMU 47 detects the angular velocity and the acceleration of the electronic device 100.

The main processor 48 controls the global navigation satellite system (GNSS) module 40, the wireless communication module 41, the CODEC 42, the speaker 43, the microphone 44, the display module 45, the input module 46, and the IMU 47.

The memory 49 stores a program and data required for the image signal processor 30, acquired image data, and a program and data required for the main processor 48.

The electronic device 100 having the above-described configuration is a mobile apparatus such as a smartphone in this embodiment, but may be other types of electronic devices including a plurality of camera modules.

<Flow of Data in the Electronic Device 100>

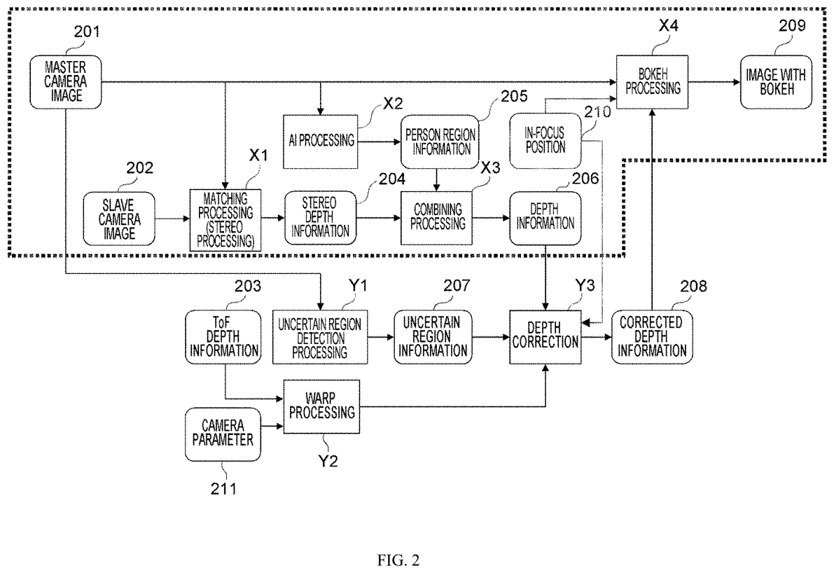

FIG. 2 is a diagram illustrating an example of a flow of data for generating the camera image of the electronic device 100.

As shown in FIG. 2, the image signal processor 30 controls the master camera module 11, the slave camera module 12, and the range sensor module 20 to acquire the camera image based on the master camera image 201 acquired by the master camera module 11, the slave camera image 202 acquired by the slave camera module 12, and the ToF depth information 203 acquired by the range sensor module 20.

The image signal processor 30 acquires stereo depth information 204 by matching processing (stereo processing) X1 of the master camera image 201 and the slave camera image 202 as shown in FIG. 2.

The image signal processor 30 also extracts person region information (in a broader sense, subject region information) 205 that defines the region of the subject in the master camera image 201 by performing AI processing (image processing) X2 on the region of the subject.

The image signal processor 30 further acquires depth information 206 of the master camera image 201 by performing combining processing X3 on the stereo depth information 204 and the extracted person region information (subject region information) 205.

The image signal processor 30 also performs an uncertain region detection processing Y1 to detect an uncertain region in the master camera image 201. The uncertain region is a region on which the matching processing X1 cannot be performed based on the master camera image 201 and the slave camera image 202. The uncertain region is a region where parallax cannot be calculated by means of the stereo depth information of a stereo image. Specifically, the uncertain region is a low texture region or a repeated pattern region.

The image signal processor 30 acquires uncertain region information 207 relating to the detected uncertain region in the master camera image 201.

The image signal processor 30 also performs a warp processing Y2 to match a FOV (field of view) of the ToF depth information with that of the master camera image. The warp processing Y2 is performed based on the ToF depth information and camera parameter 211. The camera parameter 211 includes camera parameters of the master camera module 11 and the range sensor module 20.

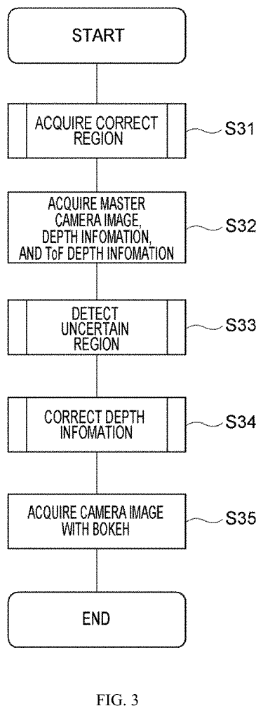

The image signal processor 30 also performs a depth correction Y3 to correct the depth information 206 of the uncertain region. The depth correction Y3 is performed based on the ToF depth information 203, the depth information 206, the uncertain region information 207 and the in-focus position 210. Corrected depth information 208 is acquired by the depth correction Y3. The depth correction Y3 will be described in detail later with reference to FIG. 3.

With respect to a non-detection region, for which no ToF depth information is detected (for example, a foreground and a background of the subject), the image signal processor 30 may acquire the corrected depth information 208 in the depth correction Y3 by replacing depth information of the non-detection region with depth information for correction that meets a user's instruction.

As described above, the image signal processor 30 acquires the corrected depth information 208 by correcting the depth information 206 based on the master camera image 201 and the ToF depth information 203. The depth information 206 is acquired based on the stereo image which is acquired by the matching processing X1.

The image signal processor 30 then performs a bokeh processing X4 on the master camera image 201 based on the corrected depth information 208 such that a camera image with bokeh (also referred to as image with bokeh) 209 is obtained.

The bokeh processing X4 may be performed in consideration of the in-focus position 210. For example, the camera image with bokeh 209 is generated by emphasizing more bokeh as the difference between the corrected depth information 208 and an average value of the depth information around the in-focus position 210 increases.

<Method of Controlling the Electronic Device 100>

An example of a method of controlling the electronic device 100 described above will now be described. In particular, an example of a flow of the electronic device 100 for acquiring a camera image with appropriate bokeh will be described below.

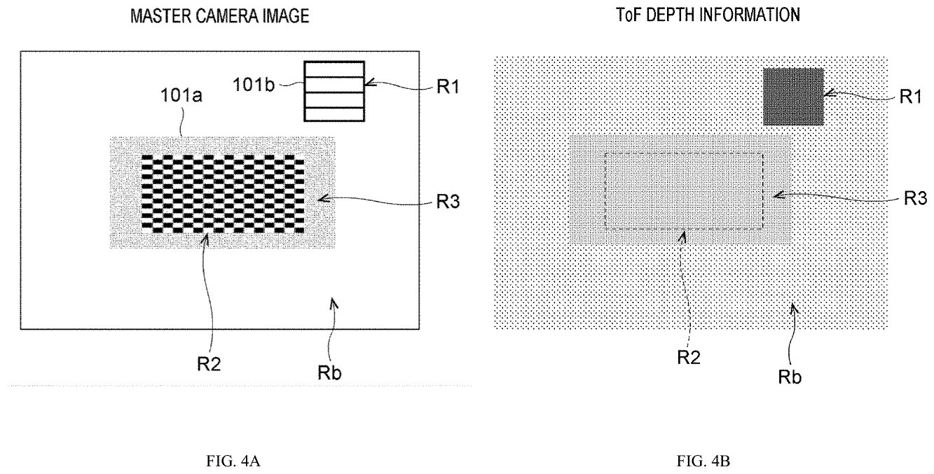

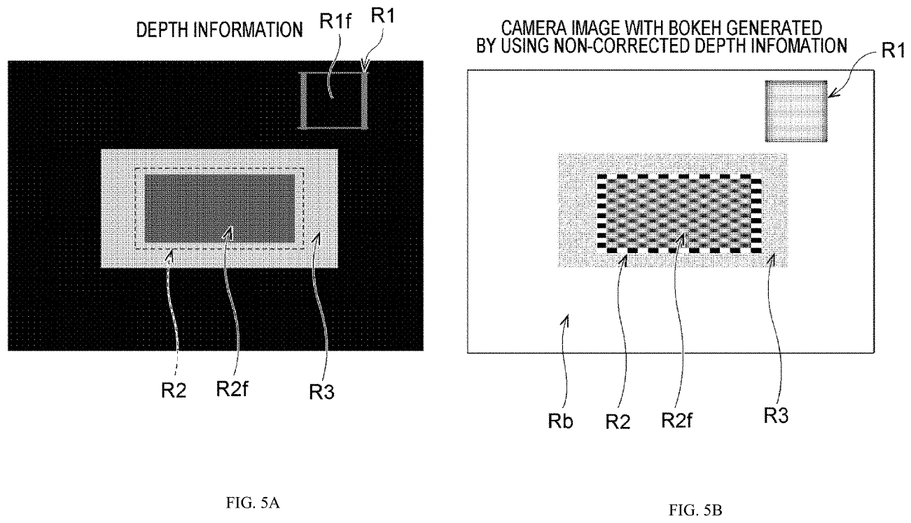

FIG. 3 is a diagram illustrating an example of a flow for generating a camera image with bokeh in the electronic device 100. FIG. 4A is a diagram illustrating an example of the master camera image taken by the electronic device 100. FIG. 4B is a diagram illustrating an example of the ToF depth information corresponding to the master camera image shown in FIG. 4A. FIG. 5A is a diagram illustrating an example of the depth information corresponding to the master camera image shown in FIG. 4A. FIG. 5B is a diagram illustrating an example of a camera image with bokeh acquired by performing the bokeh processing X4 on the master camera image based on non-corrected depth information.

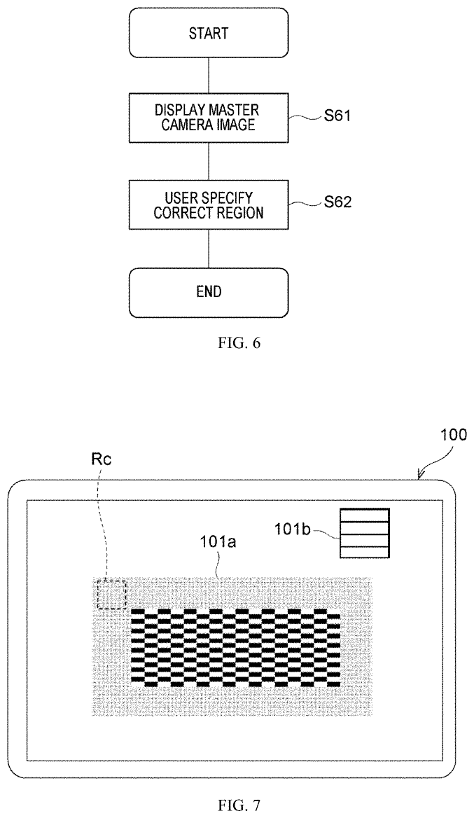

The image signal processor 30 acquires a correct region defined by the in-focus position 210. For example, the correct region is a circular or rectangular region centered on the in-focus position. FIG. 6 is a diagram illustrating an example of a flow for acquiring the correct region.

The correct region is an in-focus region which has neither a checkered pattern (i.e., low texture region) nor a plurality of horizontally long plates (i.e., repeated pattern region).

According to the example flow shown in FIG. 6, the display module 45 displays a master camera image taken by the master camera module 11 (block S61). As shown in FIG. 7, the master camera image includes the close subject 101a and the far subject 101b. In this example, the subject 101a has a plate-like member and a checkered pattern drawn on the front surface of the plate-like member. The subject 101b is a plurality of horizontally long plates which are arranged in the vertical direction.

A user specifies a correct region (block S62). For example, the user specifies a correct region by tapping a touch panel of the display module 45. In this example, as shown in FIG. 7, the correct region Rc is specified on a part of the front surface that is not the checkered pattern. Please note that the electronic device 100 (e.g., the image signal processor 30 or the main processor 48) may specify a correct region.

The image signal processor 30 acquires the master camera image (FIG. 4A), the depth information (FIG. 5A) and the ToF depth information (FIG. 4B) by controlling the master camera module 11, the slave camera module 12, and the range sensor module 20 (block S32).

FIG. 4A shows a diagram illustrating an example of the master camera image. The master camera image has the close subject 101a and the far subject 101b. In FIG. 4A, a region R1 indicates a region of the subject 101b, a region R2 indicates a region of the checkered pattern, a region R3 indicates a region obtained by removing the checkered pattern from the subject 101a. A background region Rb indicates a background region.

FIG. 5A shows an example of the depth information corresponding to the master camera image shown in FIG. 4A. A region R1f is a part of the region R1. Depth information in the region R1f is not correct due to low texture. Similarly, a region R2f is a part of the region R2. Depth information in the region R2f is not correct due to repeated pattern.

FIG. 4B shows that, in a detection region where the ToF depth information is detected, a brighter portion indicates that an object is closer, and shows that a non-detection region where no ToF depth information is detected is shaded. The background region Rb is the non-detection region.

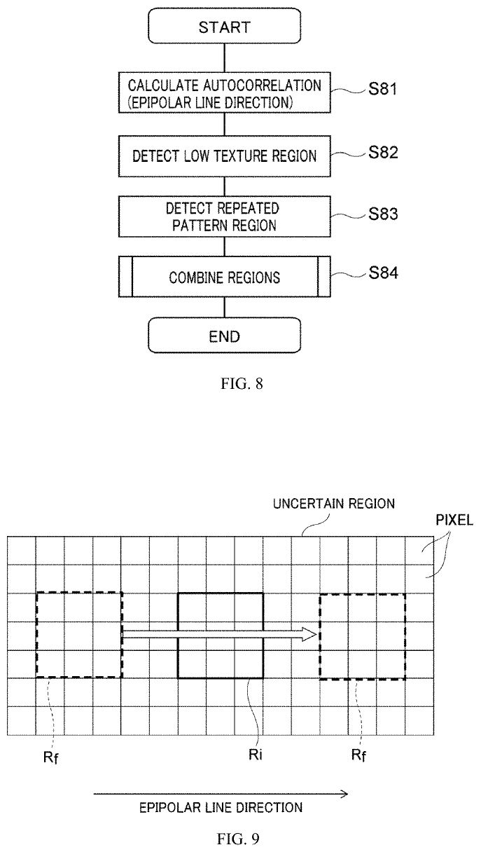

The image signal processor 30 performs the uncertain region detection processing for detecting an uncertain region in which the stereo processing cannot be performed on the master camera image and the slave camera image (block S33). The block S33 will be described in detail later with reference to FIG. 8.

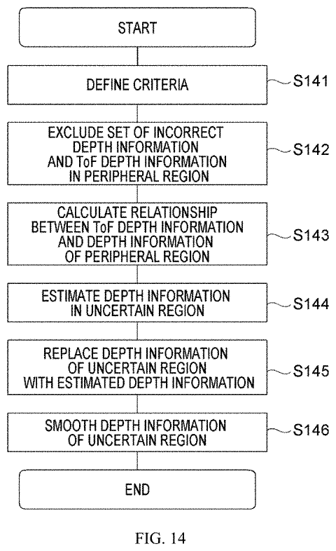

The image signal processor 30 acquires a corrected depth information by correcting the depth information corresponding to the uncertain region (block S34). Examples of depth information corresponding to the uncertain region are those having no depth value, or having no value but interpolated using depth values of surrounding portions. The block S34 will be described in detail later with reference to FIG. 14.

The image signal processor 30 performs the bokeh processing X4 on the master camera image to acquire the camera image with bokeh 209 (block S35). As shown in FIG. 5B, a camera image with bokeh that is obtained by the bokeh processing X4 has bokeh in a region R2f that should not have bokeh. This is because a depth information in the region R2f which is a part of the region R2 is not correct due to a repeated pattern as shown in FIG. 5A.

<Detail of the Uncertain Region Detection Processing>

An example of a flow of the uncertain region detection processing (i.e., the block S33) will be described with reference to FIGS. 8 to 11.

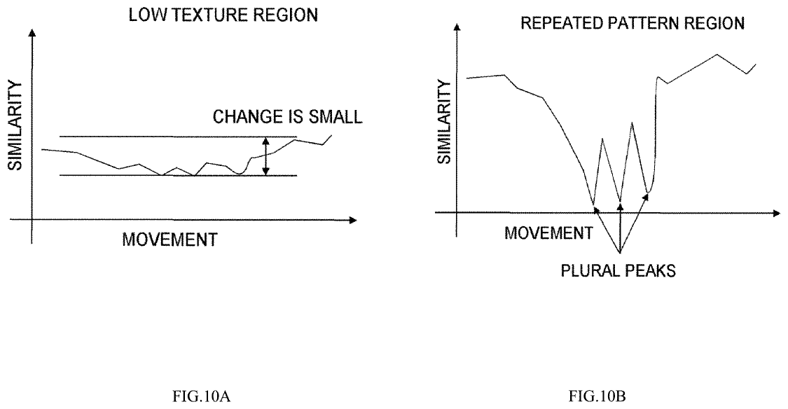

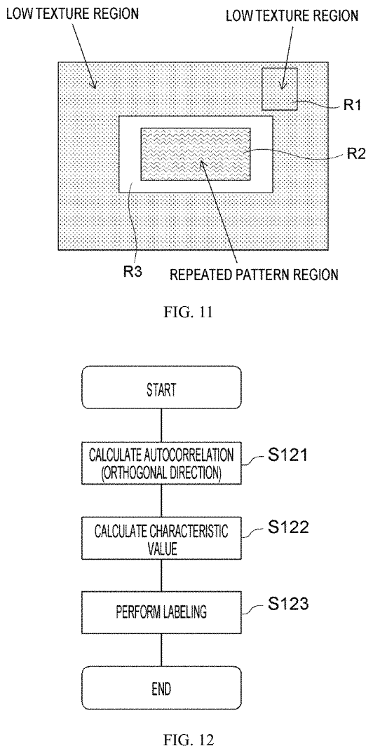

FIG. 8 is a diagram illustrating an example of a flow of the uncertain region detection processing. FIG. 9 is a diagram illustrating an autocorrelation calculation model in the flow of the uncertain region detection processing. FIG. 10A is a diagram illustrating an example of a relationship between the movement of a reference region relative to a region of interest in an uncertain region that is labeled as a low texture region and the similarity obtained by means of the autocorrelation. FIG. 10B is a diagram illustrating an example of a relationship between the movement of a reference region relative to a region of interest in an uncertain region that is labeled as a repeated pattern region and the similarity obtained by means of the autocorrelation calculation. FIG. 11 is a diagram illustrating an example of an uncertain region labeled as the low texture region and an example of an uncertain region labeled as the repeated pattern region.

The image signal processor 30 performs an autocorrelation calculation with a reference region of the master camera image being moved by a predefined movement amount relative to a region of interest, thereby calculating a degree of similarity (characteristic value) between the region of interest and the reference region (block S81).

Specifically, as shown in FIG. 9, the image signal processor 30 performs an autocorrelation calculation on the master camera image with a reference region Rf being moved relative to a region of interest Ri by a predefined movement amount in an epipolar line direction, thereby calculating a degree of similarity (characteristic value) between the region of interest Ri and the reference region Rf. The epipolar line is that for a parallel stereo image.

In computing the similarity in the autocorrelation calculation in the uncertain region detection processing, a sum of squared difference (SSD) method, a sum of absolute difference (SAD) method, a normalized cross correlation (NCC) method, a zero means normalized cross correlation (ZNCC) method, or a summed normalized cross correlation (SNCC) method may be used.

The image signal processor 30 detects a region in which a change in the calculated degree of similarity with respect to a predefined movement amount is smaller than a predefined value (block S82), and labels the detected region as a low texture region.

For example, if, in a region, a frequency (characteristic value) that is based on an average value of the peak intervals or a mode value of peaks of the similarity with respect to a predefined movement amount is less (smaller) than a predefined label reference value, the image signal processor 30 labels the region as a low texture region (see FIGS. 10A and 11).

The image signal processor 30 may further classify low texture regions based on the magnitude of the change in (change in the depth of low point of) similarity.

The image signal processor 30 detects a region in which there are a plurality of peaks in the calculated degree of similarity with respect to a predefined movement amount (block S83), and labels the detected region as a repeated pattern region.

For example, if, in a region, a frequency (characteristic value) that is based on an average value of the peak intervals or a mode value of peaks of the similarity with respect to a predefined movement amount is equal to or more (greater) than a predefined label reference value, the image signal processor 30 labels the region as a repeated pattern region (see FIGS. 10B and 11).

The image signal processor 30 combines the labeled repeated pattern region and the labeled low texture region (block S84).

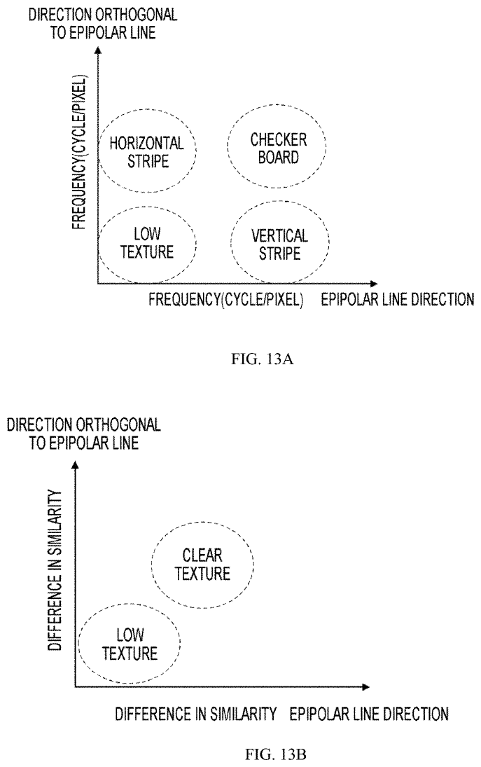

FIG. 12 shows a diagram illustrating an example of a flow of combining operations in the block S84. FIG. 13A is a diagram illustrating an example of a relationship between frequency (characteristic value) and texture labeling. FIG. 13B is a diagram illustrating an example of a relationship between differences in similarity.

In the combining flow (block S84), first, the image signal processor 30 performs an autocorrelation calculation on the master camera image by moving the reference region Rf relative to the region of interest Ri by a predefined movement amount in a direction orthogonal to the epipolar line, thereby calculating the degree of similarity (characteristic value) between the region of interest Ri and the reference region Rf (block S121).

Please note that the autocorrelation calculation in the direction orthogonal to the epipolar line may be omitted if the processing time of the image signal processor 30 needs to be reduced.

The image signal processor 30 calculates the characteristic value (frequency) based on the degree of similarity calculated in the above-described autocorrelation calculation (block S122), links pixels having similar characteristic values in uncertain regions, classifies linked pixel groups of the uncertain regions (see FIG. 13A), and labels the groups (block S123).

As described above, the characteristic value or the frequency is calculated based on the average value of the intervals between the peaks or the mode value of the peaks of the degree of similarity. The low texture regions are labeled based on the depth of the low point of the degree of similarity. The clear texture regions are excluded from the autocorrelation calculation in advance (FIG. 13B).

<Details of the Depth Information Correction Processing>

An example of a flow of depth information correction processing (i.e., the block S34) will be described with reference to FIGS. 14 to 20.

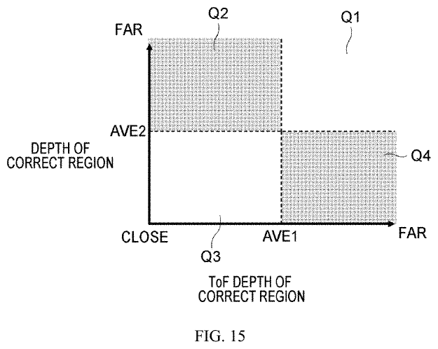

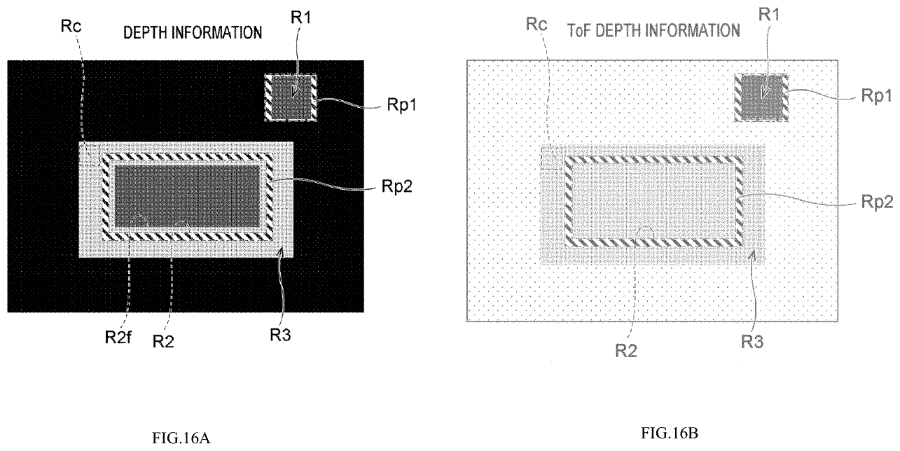

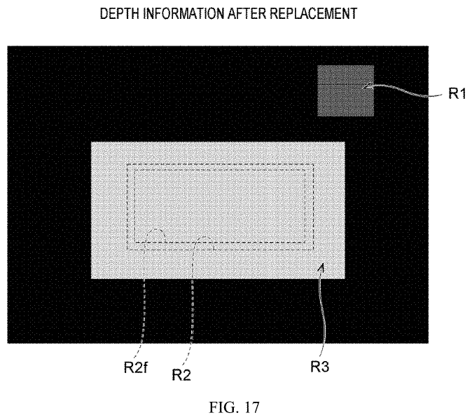

FIG. 14 is a diagram illustrating an example of a flow of the depth information correction processing. FIG. 15 is a diagram illustrating an example of criteria for excluding an incorrect set of the depth information and the ToF depth information. FIG. 16A shows a diagram illustrating an example in which peripheral regions Rp1 and Rp2 are added to FIG. 5A. FIG. 16B shows a diagram in which the peripheral regions Rp1 and Rp2 are added to FIG. 4B. FIG. 17 shows a diagram illustrating an example of the depth information after replacement processing.

FIGS. 16A, 16B and 17 show diagrams when there is no leakage (or seepage) in the uncertain region. The “leakage” occurs due to the processing for smoothing the depth information of the uncertain region. The processing is automatically performed by the electronic device 100 (e.g., the image signal processor 30) even if the uncertain region does not include an in-focus position.

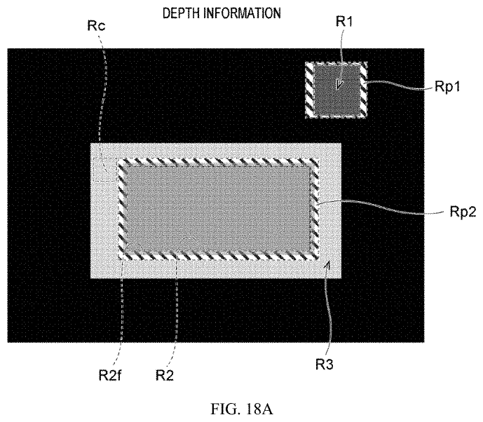

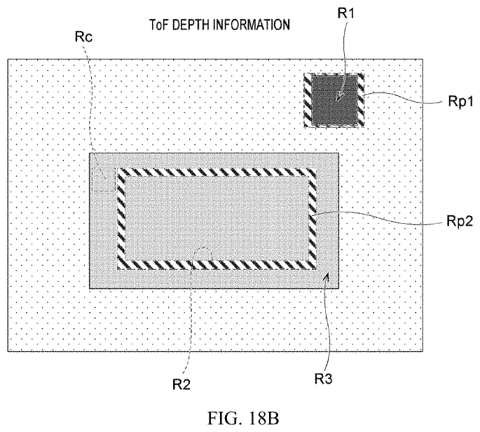

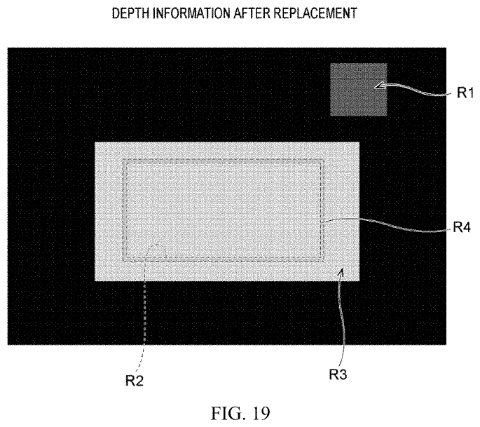

FIG. 18A is a diagram in which the peripheral regions Rp1 and Rp2 are added to FIG. 5A. FIG. 18B is a diagram in which the peripheral regions Rp1 and Rp2 are added to FIG. 4B. FIG. 19 is a diagram illustrating another example of the depth information after replacement processing. FIGS. 18A, 18B and 19 show the diagrams when there is leakage. The uncertain region R2 expands due to the smoothing processing and infiltrates the peripheral region Rp2.

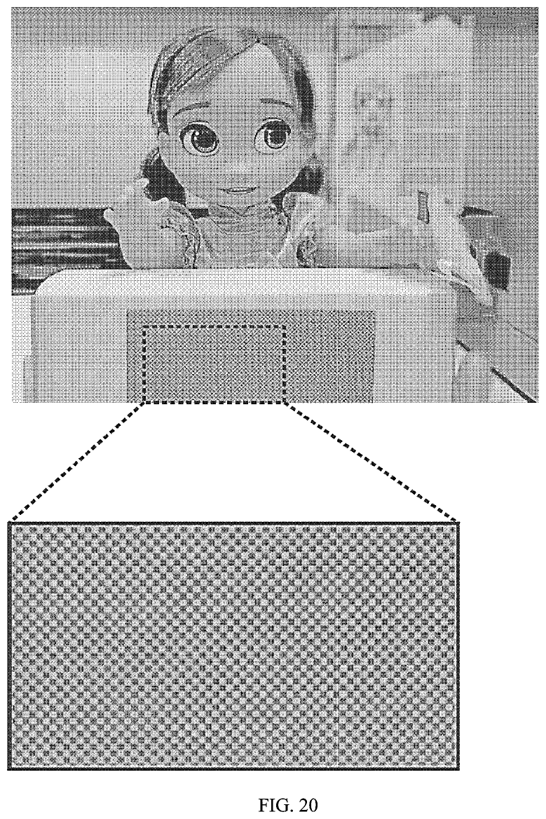

FIG. 20 is a diagram illustrating an example of a camera image after the depth information correction processing according to the present disclosure.

The image signal processor 30 defines criteria (block S141). The criteria are used to exclude incorrect data in the peripheral regions Rp1 and Rp2.

As shown in FIGS. 16A and 16B, the peripheral region Rp1 is a surrounding region which surrounds the uncertain region R1, and the peripheral region Rp2 is a surrounding region which surrounds the uncertain region R2. A peripheral region is a region adjacent to the uncertain region. The peripheral region is in contact with the uncertain region. Alternatively, a peripheral region may be separated from the uncertain region by a gap. It is desirable that the gap is larger than the amount of leakage of the uncertain region.

In S141, the criteria are defined based on the correct region Rc that is an in-focus area which has neither a low texture region nor a repeated pattern region. For example, in order to define the criteria, the image signal processor 30 calculates an average value Ave1 (first average value) of the ToF depth information of the correct region Rc and an average value Ave2 (second average value) of the depth information of the correct region Rc.

As shown in FIG. 15, a graph with the ToF depth information on the horizontal axis and the depth information on the vertical axis is divided into four quadrants Q1, Q2, Q3 and Q4 by the average values AVE1 and AVE2.

The quadrant Q2 is an incorrect region where ToF depth information is less than the first average value AVE1 and depth information is greater than the second average value AVE2. The quadrant Q4 is an incorrect region where ToF depth information is greater than the first average value AVE1 and depth information is less than the second average value AVE2.

A set of depth information and ToF depth information in the Q2 and the Q4 is considered incorrect and excluded as an illegal value. On the other hand, the Q1 and the Q3 are correct regions and thus a set of depth information and ToF depth information in the Q1 and Q3 is not excluded.

The image signal processor 30 excludes a set of incorrect depth information and ToF depth information in the peripheral region based on the criteria (block S142). For example, one or more sets of depth information and ToF depth information in the Q2 and the Q4 are excluded from data used in the next block S143.

The image signal processor 30 calculates a relationship between ToF depth information of the peripheral region and depth information of the peripheral region (block S143). The calculation in the block S143 may be performed by statistical method, e.g., regression analysis or histogram analysis etc. Accuracy of the calculated relationship is high since the incorrect values in the peripheral region are excluded in advance.

As a result of the block S143, the following model can be obtained:

Y=aX+b (1)

where Y is a depth value, X is a ToF depth value, and a and b are parameters estimated by the regression analysis.

The image signal processor 30 estimates depth information in the uncertain region based on the relationship (i.e., the model defined by the formula (1)) (block S144). The estimation processing is performed for pixels where ToF depth information could be detected. That is to say, in the example shown in FIG. 4B, estimation processing is not performed for pixels in the background region Rb since it is a non-detection region where ToF depth information could not be detected.

The image signal processor 30 replaces the depth information of the uncertain region with the estimated depth information of the uncertain region, thereby acquiring the corrected depth information (block S145). As shown in FIG. 17, incorrect depth information in the region R2f has been completely replaced with the estimated depth information. As a result, depth values in the region R2 become uniform.

In contrast with this, in a case shown in FIG. 19, incorrect depth information in a region R4 remains due to the “leakage” described above. The region R4 is a region where the uncertain region R2 expands (i.e., “leakage” portion).

The image signal processor 30 smooths the depth information of the uncertain region based on the depth information of the peripheral region (block S145). Thereby, the remaining incorrect depth information in the region R4 can be modified and depth values in the region R2 become uniform.

Please note that the blocks S142 to S146 are performed for each uncertain region. In case of FIG. 16A, the blocks S142 to S146 are respectively performed for the uncertain regions R1 and R2.

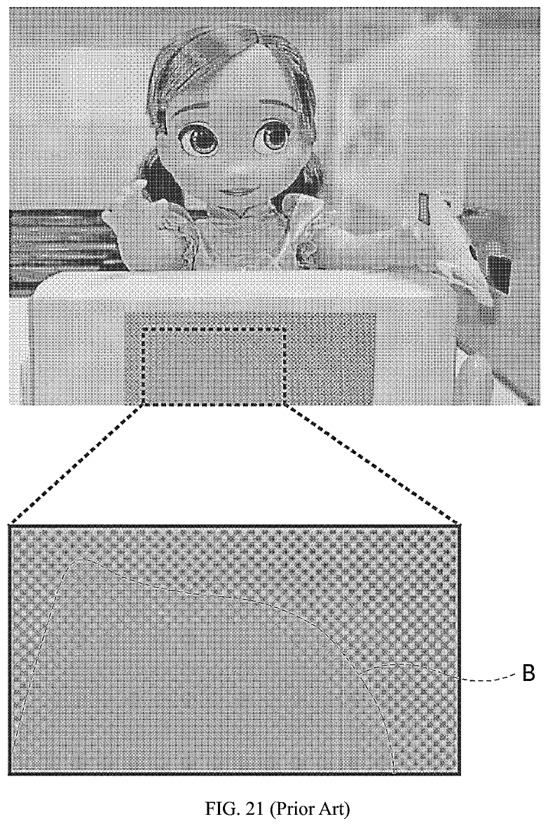

According to the flow described above, a camera image with appropriate bokeh can be generated. For example, as shown in FIG. 20, an inappropriate bokeh in the checkered pattern has been corrected. The bokeh region B in FIG. 21 has been corrected to be an in-focus region.

In at least one embodiment, the blocks S141 and S142 may be omitted if an exclusion processing is not performed.

In at least one embodiment, the block S146 may be omitted if a smoothing processing is not performed. For example, if a peripheral region is set to be separated from the uncertain region by a gap which is larger than the amount of leakage of the uncertain region, the block S146 may be omitted.

In at least one embodiment, the uncertain region may be dilated by performing morphological processing between the S141 and the S142.

According to the present disclosure, the uncertain region detection processing is performed to detect an uncertain region where depth information may be false, and the depth information correction processing is performed to correct depth information of the detected uncertain region based on the relationship between the ToF depth information of a peripheral region adjacent to the uncertain region and the depth information of the peripheral region. Thereby, an image with appropriate bokeh can be generated even if a relationship between the stereo depth information and the ToF depth information is not clear, or even if depth information is false due to low texture or repeated pattern of an object.

Further, according to the present disclosure, incorrect data in the peripheral region are excluded before calculating the relationship by means of the criteria based on the correct region defined by the in-focus position. Thereby, an accuracy of the relationship can be improved and a high accuracy of correcting depth information can be achieved.

In the description of embodiments of the present disclosure, it is to be understood that terms such as “central”, “longitudinal”, “transverse”, “length”, “width”, “thickness”, “upper”, “lower”, “front”, “rear”, “back”, “left”, “right”, “vertical”, “horizontal”, “top”, “bottom”, “inner”, “outer”, “clockwise” and “counterclockwise” should be construed to refer to the orientation or the position as described or as shown in the drawings in discussion. These relative terms are only used to simplify the description of the present disclosure, and do not indicate or imply that the device or element referred to must have a particular orientation, or must be constructed or operated in a particular orientation. Thus, these terms cannot be constructed to limit the present disclosure.

In addition, terms such as “first” and “second” are used herein for purposes of description and are not intended to indicate or imply relative importance or significance or to imply the number of indicated technical features. Thus, a feature defined as “first” and “second” may comprise one or more of this feature. In the description of the present disclosure, “a plurality of” means “two or more than two”, unless otherwise specified.

In the description of embodiments of the present disclosure, unless specified or limited otherwise, the terms “mounted”, “connected”, “coupled” and the like are used broadly, and may be, for example, fixed connections, detachable connections, or integral connections; may also be mechanical or electrical connections; may also be direct connections or indirect connections via intervening structures; may also be inner communications of two elements which can be understood by those skilled in the art according to specific situations.

In the embodiments of the present disclosure, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are in contact via an additional feature formed therebetween. Furthermore, a first feature “on”, “above” or “on top of” a second feature may include an embodiment in which the first feature is orthogonally or obliquely “on”, “above” or “on top of” the second feature, or just means that the first feature is at a height higher than that of the second feature; while a first feature “below”, “under” or “on bottom of” a second feature may include an embodiment in which the first feature is orthogonally or obliquely “below”, “under” or “on bottom of” the second feature, or just means that the first feature is at a height lower than that of the second feature.

Various embodiments and examples are provided in the above description to implement different structures of the present disclosure. In order to simplify the present disclosure, certain elements and settings are described in the above. However, these elements and settings are only by way of example and are not intended to limit the present disclosure. In addition, reference numbers and/or reference letters may be repeated in different examples in the present disclosure. This repetition is for the purpose of simplification and clarity and does not refer to relations between different embodiments and/or settings. Furthermore, examples of different processes and materials are provided in the present disclosure. However, it would be appreciated by those skilled in the art that other processes and/or materials may also be applied.

Reference throughout this specification to “an embodiment”, “some embodiments”, “an exemplary embodiment”, “an example”, “a specific example” or “some examples” means that a particular feature, structure, material, or characteristics described in connection with the embodiment or example is included in at least one embodiment or example of the present disclosure. Thus, the appearances of the above phrases throughout this specification are not necessarily referring to the same embodiment or example of the present disclosure. Furthermore, the particular features, structures, materials, or characteristics may be combined in any suitable manner in one or more embodiments or examples.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, in which it should be understood by those skilled in the art that functions may be implemented in a sequence other than the sequences shown or discussed, including in a substantially identical sequence or in an opposite sequence.

The logic and/or step described in other manners herein or shown in the flow chart, for example, a particular sequence table of executable instructions for realizing the logical function, may be specifically achieved in any computer readable medium to be used by the instructions execution system, device or equipment (such as a system based on computers, a system comprising processors or other systems capable of obtaining instructions from the instructions execution system, device and equipment executing the instructions), or to be used in combination with the instructions execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instructions execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs comprise one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks, CD, etc.

Although embodiments of the present disclosure have been shown and described, it would be appreciated by those skilled in the art that the embodiments are explanatory and cannot be construed to limit the present disclosure, and changes, modifications, alternatives and variations can be made in the embodiments without departing from the scope of the present disclosure.

What is claimed is:

1. An electronic device comprising:
a first camera configured to acquire a first image of a subject;
a second camera configured to acquire a second image of the subject;
a range sensor configured to emit a pulsed light toward the subject and detect a reflected light of the pulsed light reflected from the subject, and acquire time of flight (ToF) depth information; and
an image signal processor configured to acquire an image with bokeh, based on the first image, the second image, and the ToF depth information, wherein the image with bokeh is the first image with one or more bokeh portions,
wherein the image signal processor is configured to:
acquire a depth information of a stereo image by matching the first image and the second image;
correct the depth information of the stereo image based on the first image and the ToF depth information; and
acquire the corrected depth information.

2. The electronic device according to claim 1, wherein the image signal processor is configured to:
detect an uncertain region in the first image, wherein the matching of the first image and the second image cannot be performed;
correct the depth information of the uncertain region, based on a relationship between the ToF depth information of a peripheral region adjacent to the uncertain region and the depth information of the peripheral region; and
acquire the image with bokeh based on the corrected depth information.

3. The electronic device according to claim 2, wherein the peripheral region is in contact with the uncertain region.

4. The electronic device according to claim 2, wherein the peripheral region is separated from the uncertain region by a gap.

5. The electronic device according to claim 4, wherein the gap is larger than an amount of leakage of the uncertain region, the leakage occurring due to a processing for smoothing the depth information of the uncertain region.

6. The electronic device according to claim 2, wherein the peripheral region surrounds the uncertain region.

7. The electronic device according to claim 2, wherein to correct the depth information, the image signal processor is configured to calculate the relationship by at least one of regression analysis and histogram analysis.

8. The electronic device according to claim 2, wherein to detect the uncertain region, the image signal processor is configured to,
perform an autocorrelation calculation on the first image by moving a reference region relative to a region of interest by a predefined movement amount, thereby obtain a similarity between the region of interest and the reference region,
detect a first region in which a change in the similarity with respect to the predefined movement amount is smaller than a predefined value, and label the first region as a low texture region, and
detect a second region in which a plurality of peaks in the similarity are repeatedly found with respect to the predefined movement amount, and label the second region as a repeated pattern region.

9. The electronic device according to claim 8, wherein to correct the depth information, the image signal processor is configured to, define criteria based on a correct region that is an in-focus area which has neither the low texture region nor the repeated pattern region, exclude a set of incorrect depth information and ToF depth information in the peripheral region based on the criteria, and calculate the relationship based on the depth information and the ToF depth information in the peripheral region.

10. The electronic device according to claim 9, wherein to correct the depth information, the image signal processor is configured to, calculate a first average value of the ToF depth information of the correct region and a second average value of the depth information of the correct region, and exclude a set of the depth information and the ToF depth information within a first incorrect region and a set of the depth information and the ToF depth information within a second incorrect region, the first incorrect region being a region where the ToF depth information is greater than the first average value and the depth information is less than the second average value, the second incorrect region being a region where the ToF depth information is less than the first average value and the depth information is greater than the second average value.

11. The electronic device according to claim 9, wherein to correct the depth information, the image signal processor is configured to, estimate a depth information of the uncertain region based on the relationship.

12. The electronic device according to claim 11, wherein to correct the depth information, the image signal processor is configured to, replace the depth information of the uncertain region with the estimated depth information, thereby acquire the corrected depth information.

13. The electronic device according to claim 9, wherein the correct region is specified by a user of the electronic device.

14. The electronic device according to claim 9, further comprising:
a display configured to display the first image;
an input apparatus configured to input a position information which indicates a portion of the first image, the position information being used to define the correct region; and
a main processor configured to control the display and the input apparatus.

15. The electronic device according to claim 2, wherein to correct the depth information, the image signal processor is configured to, smooth the depth information of the uncertain region based on the depth information of the peripheral region.

16. The electronic device according to claim 1, wherein a resolution of the ToF depth information detected by the range sensor is lower than a resolution of stereo depth information of the stereo image that is acquired based on the first image and the second image.

17. The electronic device according to claim 8, wherein to detect the uncertain region, the image signal processor is configured to, label the repeated pattern region when a frequency based on an average value of peak intervals or a mode value of similarity with respect to the predefined movement amount is equal to or more than a predefined label reference value.

18. The electronic device according to claim 17, wherein to detect the uncertain region, the image signal processor is configured to, label the low texture region when the frequency is less than the label reference value.

19. The electronic device according to claim 8, wherein the similarity is computed in the autocorrelation calculation using one method selected from the group consisting of a sum of squared difference (SSD) method, a sum of absolute difference (SAD) method, a normalized cross correlation (NCC) method, a zero means normalized cross correlation (ZNCC) method, and a summed normalized cross correlation (SNCC) method.

20. A method for controlling an electronic device, wherein the electronic device comprises a first camera, a second camera, a range sensor, and an image signal processor; and the method comprises:
acquiring, by the first camera, a first image of a subject;
acquiring, by the second camera, a second image of the subject;
acquiring, by the range sensor, ToF depth information of the subject;
acquiring, by the image signal processor, a depth information of a stereo image by matching the first image and the second image;
correcting, based on the first image and the ToF depth information, the depth information of the stereo image, and acquiring the corrected depth information; and
acquiring, by the image signal processor, based on the corrected depth information, an image with bokeh;
wherein the image with bokeh is the first image with one or more bokeh portions.
